(19) United States
(12) Patent Application Publication
(10) Pub. No.: US 2007/0261755 A1
(43) Pub. Date: Nov. 15, 2007

(54) Apparatus for inducing gravity feed of liquids

(76) Inventor: Bruce Warrington, San Juan Capistrano, CA (US)

Correspondence Address: Edward E. Roberts, P.O. Box 3206, Dana Point, CA, 92629, US

(21) Appl. No.: 11/731,887

(22) Filed: Apr. 2, 2007

Related U.S. Application Data
(60) Provisional application No. 60/798,665, filed on May 9, 2006.

(51) Int. Cl. B67D 5/54

(52) U.S. Cl. 141/1; 141/67

(57) ABSTRACT

Apparatus and method for transferring liquids from a sealed air-tight container to a second container by means of gravity feed, the apparatus including an air pressure input line having a one-way check valve for providing pressurized air into an air space above liquid in the air-tight container and means for escape of displaced liquid from the container in response to the induced air pressure, and an output line for feeding the displaced liquid to the second container.

### CLAIM FOR BENEFIT OF EARLIER FILING DATE

The present utility application claims the benefit of U.S. Provisional Application No. 60/798,665 filed on 9 May 2006 and entitled “Apparatus for Inducing Gravity Feed of Liquids”. The present utility application has the same inventor, subject matter and title as the aforesaid Provisional Application.

### BACKGROUND

The background of the invention will be discussed in two parts.

1. Field of the Invention

The present invention relates to a mobile liquid transfer apparatus and particularly to an apparatus for transfer of liquid from one container to another by inducing gravity feed by means of pressured air from a closed container to another container.

2. Description of the Related Art

U.S. Pat. No. 6,036,446 to Goodman issued on 14 Mar. 2000 and entitled “Fluid Transfer with Concurrent System Movement for Liquid Vacuum” is cited as background for this invention. Goodman discloses mobile apparatus for transporting a liquid which includes an outlet transfer line for liquid transfer to a remote container. Also of interest is U.S. Pat. No. 5,230,374 to Dawson issued on 27 Jul. 1993 and entitled “Mobile Liquid Transferring Apparatus. Most related art devices include a flaw in that corrosive liquids deteriorate the pump seals required to maintain the flow of liquid, a flaw not present in the present invention in that air pressure is applied externally to displace liquid and induce flow. Flow is then maintained by gravity induced vacuum as long as the plumbing integrity is maintained and the liquid gravity exceeds the effluent container gravity. Prior art devices were not found relating to gravity feed of liquids from one container to another container under conditions as is taught by the invention.

### OBJECTS OF THE INVENTION

It is an object of the present invention to provide a new and improved apparatus for inducing gravity feed of liquid from one container to another that is easy to set up and operate. It is another object of the invention to provide a removable, hand portable container for remote site transfer of liquids by gravity feed to another container. It is also an object to provide a closed gravity feed system wherein liquid transfer from one container to another is sealed from the environment. It is a further object of the invention to provide a system which uses air pressure as the only energy source for charging the system with withdrawal and concurrent delivery of liquids drawn from one container into another container in a closed liquid interchange system. It is another object to provide a system for transferring liquid upward against gravity from one container to another. It is another object of the invention to provide such apparatus that can be efficiently and inexpensively manufactured and marketed. Other objects, aspects, features and advantages of the invention will become apparent from a reading of the specification taken in conjunction with the drawings.

### SUMMARY

The invention is a mobile apparatus for transferring liquid from a sealed container to another container by means of gravity feed. The apparatus is a closed liquid interchange system utilizing only air pressure as the energy source for initiating operation of the system. Included is an air pressure input line having a one-way check valve, tee connector means for providing the air under pressure into a closed sealed container containing liquid and for providing means for transfer of displaced liquid from the closed container to another container in response to the induced air pressure. An output line having a cut-off valve is included for feeding the displaced liquid to the second container. The system apparatus and method eliminates the need for motors, pumps, or electricity at service sites, and can eliminate open atmosphere pouring as well as electrically driven pumping during liquid transfer from one container to another. Evaporation of volatile liquids to the atmosphere is minimized and waste spillage chances are illuminated or reduced.

### DRAWINGS

FIG. 1 is an exploded view illustrating apparatus in accordance with the invention;

FIG. 2 illustrates in perspective view apparatus of the invention connected for transferring liquid from a closed container to another container in accordance with the invention;

FIG. 3 is a cross-sectional view taken along lines 3-3 of FIG. 2;

FIG. 4 is a partial cross-sectional view illustrating air being applied prior to pressurizing the container sufficiently to initiate liquid transfer; and

FIG. 5 is a partial cross-sectional view illustrating liquid transfer after sufficient air pressure has been applied to pressurize the closed container in accordance with the invention.

### DESCRIPTION

Referring now to the figures there is disclosed the apparatus of the invention and the manner in which it is utilized to transfer liquid from a first closed container to a second receiving container. Generally designated by the reference numeral 10, the apparatus provides a closed liquid interchange system utilizing only air pressure as the energy source for charging the system.

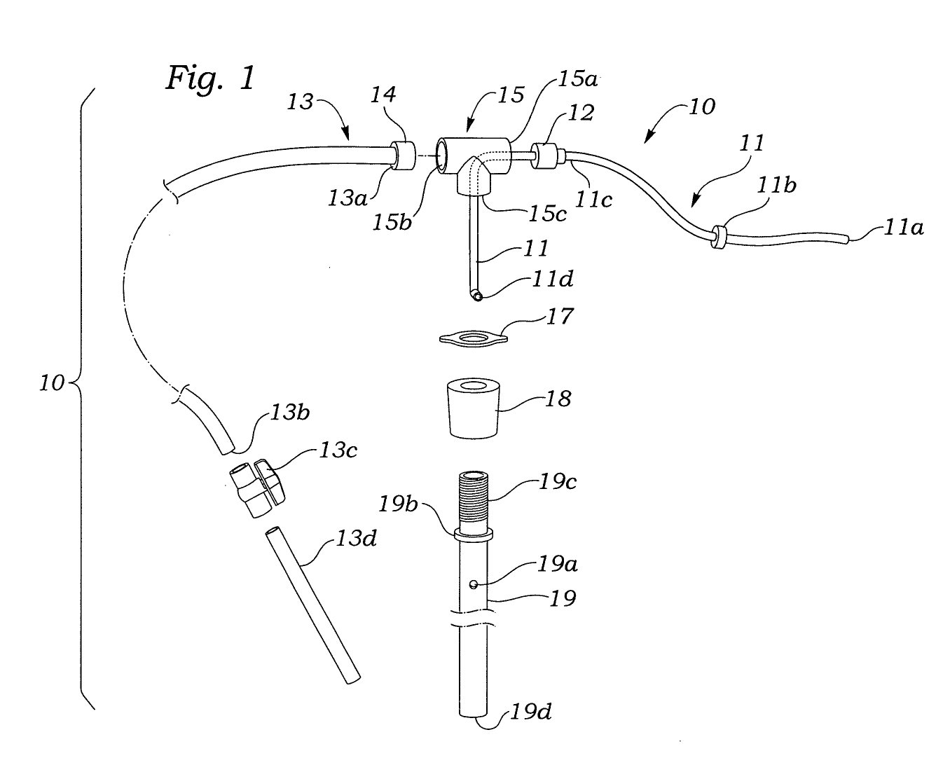

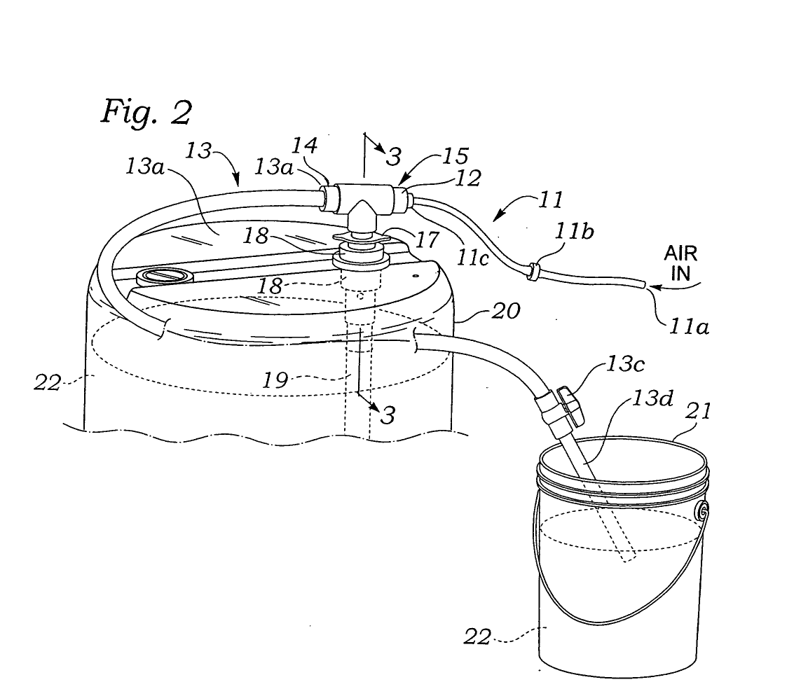

FIG. 1 is an exploded view of the apparatus 10 illustrating component parts of the invention. Shown is a generally flexible air inlet tube, generally designated 11, having an open end 11a for input of air under pressure, a check valve 11b for one-way passage of the pressurized air, and a connector/seal 12. As will be explained, upon operation of the system of the invention check valve 11b captures and holds applied air pressure thereby to pressurize the system to initiate gravity flow of liquid from a sealed container to another container. Inlet tube 11 transits through connector/seal 12 as indicated at 11c and enters connector 15 at opening 15a and then curved at an appropriate angle for extending downwardly of tee connector 15 through opening 15c to terminate at end 11d, end 11d curved and having an aperture for exhausting pressurized air from inlet 11a. Connector/seal 12 is configured for receiving tube 11 and mating with tee-like connector 15 at inlet 15a in a manner to provide an air tight seal. Pipe 19 has aperture 19a, rib 19b, top threaded portion 19c and bottom opening 19d. Further included are compression nut 17 and sealing member 18. Liquid outlet tube, generally designated 13, has a first end 13a attached to a connector/seal 14 for airtight mating with outlet 15b of tee-like connector 15, and a second end 13b attached to on-off valve 13c. An outlet tube 13d extends from valve 13c for insertion into a receiving container as is shown in FIG. 2. Thus, tee connector 15 has two female openings 15a and 15b for receiving compatible male portions of connector/seals 12 and 14, respectively, and a third opening 15c for receiving tube 11 and pipe 19. Input of pressurized air may be by a small bicycle pump or other suitable means. It is only necessary that sufficient air pressure is applied to initiate transfer flow of liquid up through pipe 19 and out of tee connector opening 15b and through outlet tube 13 on to the receiving container.

In assembly of apparatus 10 sealing member 18 is fitted over the threaded portion 19c of pipe 19 and firmly against pipe rib 19b. Compression nut 17 is then threaded onto threaded portion 19c of pipe 19 with threaded portion 19c then threaded into a receiving threaded portion (not shown) of opening 15c in a manner to provide an airtight seal. Pipe 19 is then inserted into the opening of container 20, as seen in FIG. 2, firmly seating sealing member 18 in the container 20 opening after which threaded compression nut 17 is tightened along threaded portion 19c and against sealing member 18 to effect an airtight seal. It is to be understood that other methods of compression sealing can be devised by those skilled in the art that would fall within the spirit and scope of the invention.

FIG. 2 is a perspective view illustrating the final assembly of apparatus 10 whereby liquid 22 is transferred from storage container 20 into receiving container 21, apparatus 10 installed onto container 20 in an airtight manner so to establish air pressure in container 20 sufficient to effect transfer of liquid in accordance with the invention. As indicated in phantom the lower portion of pipe 19 is immersed in liquid 22. End 19d is immersed to a sufficient depth for satisfactory operation of the invention.

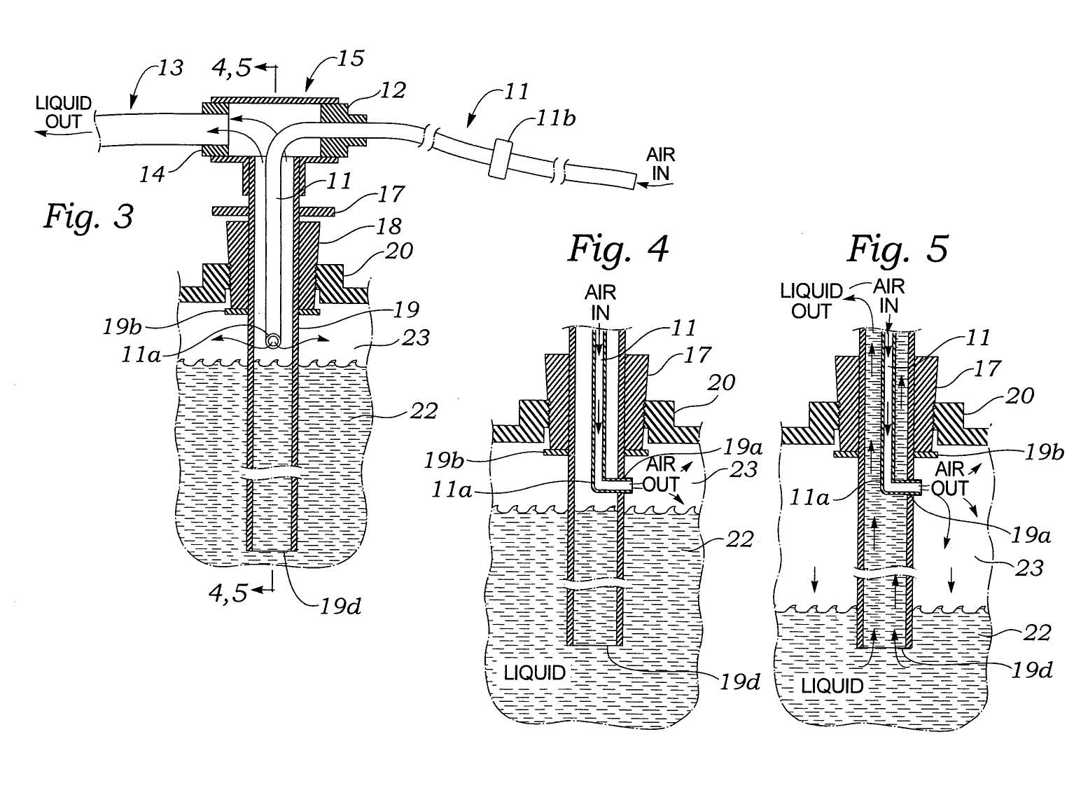

FIG. 3 is a cross-sectional view taken along the lines 3-3 of FIG. 2 illustrating the gravity feed of liquid 22 in accordance with the invention. As indicated, air under pressure is forced into air inlet tube 11, through check valve 11b and tee connector 15 to be exhausted into the air space 23 of air-tight container 20 through outlet 16a, as indicated by the arrows, and above liquid 22. Pipe 19 is immersed in liquid 22 such that with adequate air pressure in airspace 23 liquid 22 is forced up pipe 19 and flows out of connector 15 and into outlet tube 13, also as indicated by arrows. As indicated in FIG. 3 portion 19c is can be fitted into opening 15c to provide an airtight seal. Further, connector/seals 12 and 14 may be pressure fitted or otherwise sealed into openings 15a and 15b, respectively. It is understood that other variations, modifications and embodiments can be devised by those skilled in the art that would fall within the spirit and scope of the invention.

FIG. 4 is a partial cross-sectional view of the invention illustrating pressurized air being applied into airspace 23 of container 20 prior to sufficient pressurized air being provided to initiate liquid transfer out of container 20 to container 22. The flow of pressurized air is through curved end 11a of tubing 11 which is inserted through pipe aperture 19a and into air space 23.

FIG. 5 is a partial cross-sectional view of the invention illustrating sufficient pressurized air having been applied to container 20 airspace 23 so as to initiate liquid transfer from container 20 to container 22. As indicated by the arrows the pressurized air has expanded air space 23 to force liquid 22 to flow up through pipe 19, through tee connector 15, and on through outlet tube 13 to the receiving container 21. After flow is initiated, the apparatus 10 acts as a siphon to continue transfer of liquid so long as sufficient air is allowed through one-way valve into airspace 23 and the separate container 22 is positioned with a drain located such that the gravity pressure of said liquid in said container maintains liquid transfer.

Thus, in accordance with the invention, pressurized air is forced through air inlet tube 11 into air space 23 of sealed container 20 to gradually increase the air space 23 until liquid 22 flows out of container 20 and into outlet tube 13 after which with valve 13c turned to the on position liquid flows into container 21 until either the valve 13c is turned off or the liquid 22 level gets below the inlet 19d of pipe 19.

There has been shown and described new and unique apparatus for gravity feed liquid transfer from a storage container to a receiving container. Although the invention has been described with reference to certain embodiments, other variations, modifications and embodiments can be devised by those skilled in the art that would fall within the spirit and scope of the invention.

What is claimed is:

1. A fluid handling system for movement of fluid from one container to a separate container, comprising:
a container sealed and closed to the outside atmosphere for exchange of a liquid contained therein;
input means to said container having one-way valve means for providing pressurized air to an air space above said liquid while maintaining closure of said system from the outside atmosphere;
connecting means between said liquid and a separate container operable for removing said liquid from said sealed container to said separate container, said connecting means having a liquid input below the level of said liquid in said container; and
said liquid is transferred from said container into +said separate container by air pressure provided through said input means into said air space in said container.

2. The system of claim 1 wherein said one-way valve means provides sufficient additional air to said air space in response to a liquid transfer created vacuum in said air space of said container to maintain liquid exchange between said container and said separate container.

3. The system of claim 2 wherein said connecting means further includes valve means selectively operable for exchanging said liquid between said container and said separate container.

4. The system of claim 3 wherein said separate container and said connecting means comprises a gravity drain positioned between said container and said separate container, said gravity drain characterized by positioning said separate container with a drain located such that the gravity pressure of said liquid in said container maintains liquid transfer from said container into said separate container.

5. A gravity feed liquid transfer system comprising:
at least one sealed liquid sending container and at least one liquid receiving container;
means for liquid exchange between said at least one sending container and said at least one receiving container;
said means for liquid exchange including air pressure induced gravity feed exchange between said at least one sending container and said at least one receiving container; and
wherein said at least one sending container contains both liquid and an air space above said liquid and means for increasing the volume of said air space thereby to induce simultaneous gravity feed liquid exchange between said at least one sending container and said at least one receiving container.

6. The system of claim 5 wherein each of said sending container and corresponding receiving container includes:
intermediate connector means;
an air inlet tube having an open end for input of air under pressure, a check valve for one-way passage of the pressurized air, and sealable means having an aperture for receiving said inlet tube therethrough and for airtight connection to a first opening of said intermediate connector means, said inlet tube transiting said sealable means and said intermediate connector to extend a selected distance from a second opening of said intermediate connector means to terminate in an air exhaust outlet;
tubing means having a first end for sealable connection to a second opening of said intermediate connector means and for receiving said air inlet tube a selected distance therein, said tubing means including an aperture for receiving said air inlet exhaust outlet therethrough;
a liquid outlet tube having a first end for airtight mating to a third opening of said intermediate connector means, an on-off valve, and an open terminating end; and
said tubing means configured for liquid communication with said third opening and said liquid outlet tube.

7. The system of claim 6 further comprising:
said at least one sending container includes liquid therein and an airspace above said liquid;
means for sealable insertion of said tubing means wherein the other end of said tubing means and said exhaust outlet is below the surface of said liquid;
means for providing air under pressure to said air space thereby inducing gravity flow of said liquid through said tubing means and into said outlet tube;
said at least one receiving container for receiving liquid from said at least one sending container through said terminating end of said outlet tube; and
wherein said check valve is a self-tending one-way valve for automatically providing additional air in response to any liquid transfer created vacuum in said air space of said at least one sending container.

8. A fluid transfer method of exchanging liquid in a closed system without exposing the liquid to the atmosphere, said method comprising the steps of:
containing an air space above a liquid in a sealed sending container;
providing a receiving container;
interconnecting said sending container and said receiving container by a liquid conduit; and
transferring liquid from said sending container into said receiving container through said conduit in response to gravity flow induced by controllable increase of the volume of said air space in said sealed container.

9. The fluid transfer method of claim 8 wherein said liquid conduit comprises:
intermediate connector means;
an air inlet tube having an open end for input of air under pressure, a check valve for one-way passage of the pressurized air, and sealable means having an aperture for receiving said inlet tube therethrough and for airtight connection to a first opening of said intermediate connector means, said inlet tube transiting said sealable means and said intermediate connector to extend a selected distance from a second opening of said intermediate connector means to terminate in an air exhaust outlet;
tubing means having a first end for sealable connection to a second opening of said intermediate connector means and for receiving said air inlet tube a selected distance therein, said tubing means including an aperture for receiving said air inlet exhaust outlet therethrough;
a liquid outlet tube having a first end for airtight mating to a third opening of said intermediate connector means, an on-off valve, and an open terminating end; and
said tubing means configured for liquid communication with said third opening and said liquid outlet tube.

10. The fluid transfer method of claim 8 further comprising:
means for sealable insertion of said tubing means into said sending container wherein the other end of said tubing means and said exhaust outlet is below the surface of said liquid;
means for providing air under pressure to said air space thereby inducing gravity flow of said liquid through said tubing means and into said outlet tube;
at least one receiving container for receiving liquid from at least one sending container through said terminating end of said outlet tube; and
wherein said check valve is a self-tending one-way valve for automatically providing additional air in response to any liquid transfer created vacuum in said air space of said at least one sending container.
